(19) United States
(12) Patent Application Publication
(10) Pub. No.: US 2026/0066265 A1
(43) Pub. Date: Mar. 5, 2026

(54) METHOD OF MANUFACTURING BATTERY

(71) Applicant: TOYOTA JIDOSHA KABUSHIKI KAISHA, Toyota-shi (JP)

(72) Inventors: Tadashi Teranishi, Toyota-shi (JP); Masato Ono, Nagoya-shi (JP)

(73) Assignee: TOYOTA JIDOSHA KABUSHIKI KAISHA, Toyota-shi (JP)

(21) Appl. No.: 19/090,550

(22) Filed: Mar. 26, 2025

(30) Foreign Application Priority Data
Aug. 28, 2024 (JP) 2024-146704

(51) Int. Cl. H01M 4/04

(52) U.S. Cl. CPC H01M 4/0471; H01M 4/0435

(57) ABSTRACT

A method of the present disclosure of manufacturing a battery includes roller-conveying a stack such that a conveyance direction of the stack that has been subjected to heating to a temperature of 120° C. or more is changed by 45° or more along a direction changing roller, the stack including a base material layer and an electrode active material layer. Further, in the method of the present disclosure, the direction changing roller is configured to widen the stack.

### CROSS-REFERENCE TO RELATED APPLICATION

This application claims priority to Japanese Patent Application No. 2024-146704 filed on Aug. 28, 2024. The disclosure of the above-identified application, including the specification, drawings, and claims, is incorporated by reference herein in its entirety.

### BACKGROUND

### 1. Technical Field

The present disclosure relates to a method of manufacturing a battery.

### 2. Description of Related Art

As disclosed in Japanese Unexamined Patent Application Publication No. 2017-183214 (JP 2017-183214 A), Japanese Unexamined Patent Application Publication No. 2017-228349 (JP 2017-228349 A), Japanese Unexamined Patent Application Publication No. 2008-147114 (JP 2008-147114 A), Japanese Unexamined Patent Application Publication No. 2016-103402 (JP 2016-103402 A), and Japanese Unexamined Patent Application Publication No. 2017-191678 (JP 2017-191678 A), a technology relating to drying of an electrode active material layer configuring an electrode stack for a battery has been developed.

### SUMMARY

At the time of manufacturing a battery, it is desirable to reduce cracking of the electrode active material layer that has been subjected to heat treatment for drying and the like.

The present disclosure has an object to provide a method of manufacturing a battery capable of reducing cracking of an electrode active material layer that has been subjected to heat treatment.

The disclosers of the subject application and the like have found that the above-mentioned problem can be solved by the following means.

### Aspect 1

Aspect 1 of the disclosure relates to a method of manufacturing a battery, the method including roller-conveying a stack such that a conveyance direction of the stack that has been subjected to heating to a temperature of 120° C. or more is changed by 45° or more along a direction changing roller, the stack including a base material layer and an electrode active material layer.

The direction changing roller is configured to widen the stack.

### Aspect 2

In the method according to Aspect 1, the direction changing roller may include a center portion and both end portions, and a circumferential speed of the both end portions may be faster than a circumferential speed of the center portion.

### Aspect 3

In the method according to Aspect 1, the direction changing roller may be configured from two rollers at both end portions.

A conveyance roller may be further included on an upstream side from the direction changing roller in the conveyance direction.

A circumferential speed of the direction changing roller may be faster than a circumferential speed of the conveyance roller.

### Aspect 4

The method according to any one of Aspects 1 to 3 may further include drying the electrode active material layer before the roller-conveying.

The drying may include heating the stack to a temperature of 120° C. or more.

### Aspect 5

In the method according to Aspect 4, the drying may include laser-heating the stack.

With the method of the present disclosure of manufacturing a battery, the cracking of the electrode active material layer that has been subjected to heat treatment can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating an example of a method of the present disclosure of manufacturing a battery;

FIG. 2 is a schematic view illustrating an example of a direction changing roller;

FIG. 3 is a schematic view illustrating an example of the direction changing roller; and

FIG. 4 is a schematic view illustrating an example of the direction changing roller.

### DETAILED DESCRIPTION OF EMBODIMENTS

Hereinafter, an embodiment of the present disclosure is described in detail. It is to be noted that the present disclosure is not limited to the embodiment described below, and various modifications can be made thereto without departing from the gist of the disclosure.

### Method of Manufacturing Battery

A method of the present disclosure of manufacturing a battery includes roller-conveying a stack such that a conveyance direction of the stack that has been subjected to heating to a temperature of 120° C. or more is changed by 45° or more along a direction changing roller, the stack including a base material layer and an electrode active material layer. Further, in the method of the present disclosure, the direction changing roller is configured to widen the stack.

The disclosers of the subject application and the like have considered that one of the reasons why cracking is easily caused in an electrode active material layer that has been heated to a predetermined temperature that is 120° C. or more is because moisture in the electrode active material layer is reduced, and thus the flexibility of the electrode active material layer is reduced.

Regarding this point, the disclosers of the subject application and the like have found that, at the time of manufacturing a battery, when the stack is roller-conveyed such that the conveyance direction of the stack that has been subjected to heating to the temperature of 120° C. or more and includes the base material layer and the electrode active material layer is changed by 45° or more along the direction changing roller that is configured to widen the stack, the cracking of the electrode active material layer that has been subjected to heat treatment is reduced. The reason is estimated as follows, although not intended to be bound by any theory. That is, it is considered that, for example, when a stack having a temperature around room temperature is changed in direction by 45° or more along the direction changing roller, in the electrode active material layer within the stack, a plurality of electrode active materials binding to each other via a binder is divided, resulting in that cracking is caused in the electrode active material layer. In contrast, it is considered that, in the electrode active material layer within the stack that has been subjected to heating to the temperature of 120° C. or more, the flexibility of the binder is increased. It is considered that, when the stack including the electrode active material layer is changed in direction by 45° or more along the direction changing roller in this state, a moderate stress is applied to the electrode active material layer containing the binder having high flexibility, and thus the binder can be expanded and spread while keeping the electrode active materials bound to each other. Moreover, with the direction changing roller being configured to widen the stack, it is considered that a stress is applied from a plurality of directions to the electrode active material layer, and the division of the electrode active materials is further less likely to occur. As a result, it is considered that the cracking of the electrode active material layer is reduced.

It is to be noted that, in the present disclosure, a width direction relating to the term “widen” means a direction perpendicular to the conveyance direction within a plane of the stack.

Hereinafter, the method of the present disclosure of manufacturing an electrode is described with reference to the drawings. It is to be noted that dimensional relationships in the drawings do not reflect the actual dimensional relationships.

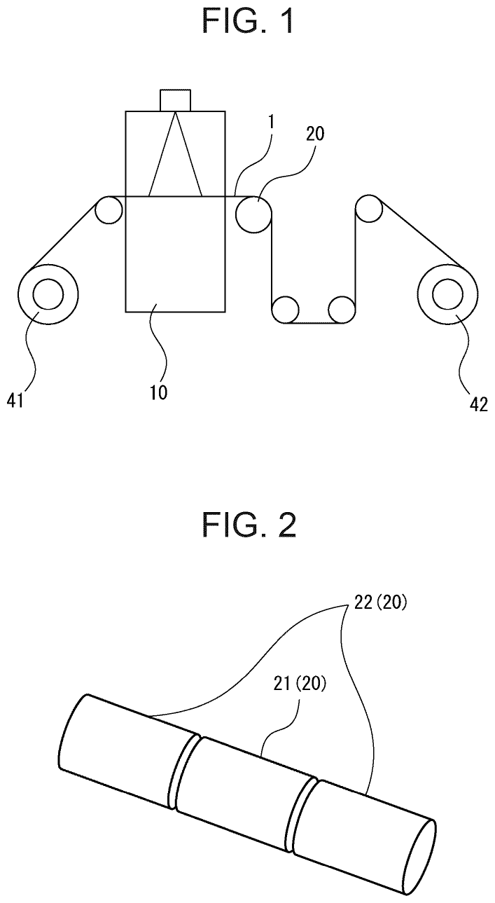

It is to be noted that FIG. 1 is a schematic view for exemplifying an aspect in which an electrode active material layer is wound from an unwinding reel 41 to a winding reel 42 via heating and roller-conveying. Further, FIG. 2 to FIG. 4 are schematic views illustrating examples of a direction changing roller to be used in the method of the present disclosure.

### Roller-Conveying Step

As exemplified in FIG. 1, the method of the present disclosure includes roller-conveying a stack 1 such that a conveyance direction of the stack 1 that has subjected to heating to a temperature of 120° C. or more is changed by 45° or more along a direction changing roller 20, the stack 1 including a base material layer and an electrode active material layer. When an angle to change the conveyance direction of the stack falls within the above-mentioned range, it is possible to effectively reduce cracking of the electrode active material layer.

The heating temperature may be 130° C. or more, 140° C. or more, 150° C. or more, 160° C. or more, 170° C. or more, 180° C. or more, 190° C. or more, or 200° C. or more, and may be 300° C. or less, 290° C. or less, 280° C. or less, 270° C. or less, 260° C. or less, or 250° C. or less. When the heating temperature falls within the above-mentioned range, it is considered that reduction in flexibility or the like is easily caused along with the reduction of moisture in the electrode active material layer and deterioration of a binder. Based on such estimation, it is particularly effective to apply the method of the present disclosure to the electrode active material layer that has been subjected to heat treatment at the temperature within the above-mentioned range.

The angle to change the conveyance direction of the stack may be 60° or more, 70° or more, 80° or more, 85° or more, or 90° or more, and may be 180° or less, 150° or less, 130° or less, 120° or less, 110° or less, 100° or less, 95° or less, or 90° or less.

In the method of the present disclosure, the direction changing roller 20 is configured to widen the stack 1. With such a configuration, a stress can be applied to the electrode active material layer from a plurality of directions, and thus the cracking of the electrode active material layer can be effectively reduced.

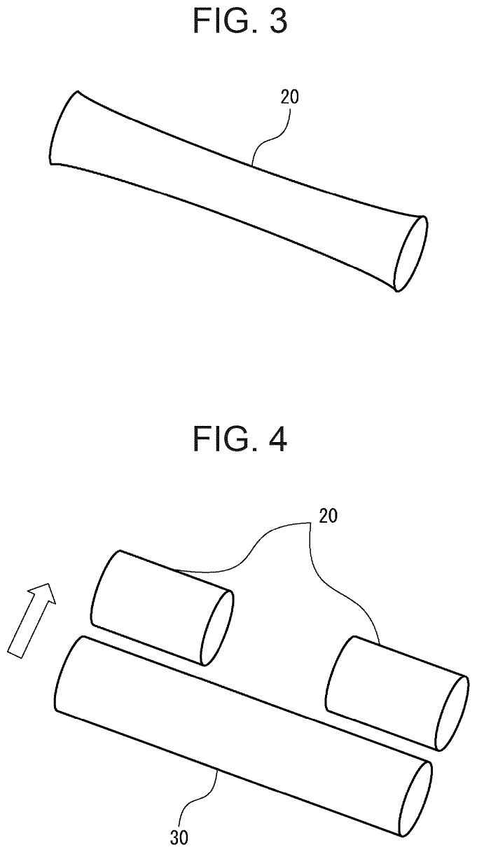

In the method of the present disclosure, the direction changing roller 20 may include a center portion 21 and both end portions 22, and a circumferential speed of the both end portions 22 may be faster than a circumferential speed of the center portion 21. As such a direction changing roller, as exemplified in FIG. 2, one that is configured from three rollers in which the circumferential speed of both end rollers (the both end portions) is faster than the circumferential speed of a center roller (the center portion) can be given. Further, as exemplified in FIG. 3, a roller having a so-called concave crown shape can be given. Further, although not shown, as the direction changing roller, one that is configured from three rollers in which the diameter of the both end rollers (the both end portions) is larger than the diameter of the center roller (the center portion) and thus the circumferential speed of the both end portions is faster than the circumferential speed of the center portion can be given.

In the method of the present disclosure, the direction changing roller 20 may be configured from two rollers at both end portions, and a conveyance roller 30 may be further included on an upstream side or a downstream side from the direction changing roller 20 in the conveyance direction. Moreover, the circumferential speed of the direction changing roller 20 may be faster than the circumferential speed of the conveyance roller 30. In particular, as exemplified in FIG. 4, the conveyance roller 30 may be included on the upstream side from the direction changing roller 20 in the conveyance direction.

When the direction changing roller is configured as described above, the stack can be easily widened, and thus the cracking of the electrode active material layer can be effectively reduced.

The direction changing roller that is configured to widen the stack is not limited to the above-mentioned aspects, and an expander roller or the like can be additionally exemplified.

The circumferential speed of the direction changing roller is not particularly limited. That is, for example, in the direction changing roller 20 as exemplified in FIG. 2, it is only required that the circumferential speed of the both end portions 22 be faster than the circumferential speed of the center portion 21. Further, for example, in the direction changing roller 20 as exemplified in FIG. 4, it is only required that the circumferential speed of the direction changing roller 20 be faster than the circumferential speed of the conveyance roller 30. It is to be noted that the arrow of FIG. 4 indicates the conveyance direction of the stack 1. The circumferential speed of the direction changing roller can be set as appropriate in consideration of the viewpoint of reducing the cracking of the electrode active material layer, the viewpoint of easiness of conveyance, and the like.

The diameter of the direction changing roller is not particularly limited, and may be 35 mm or more, 40 mm or more, 45 mm or more, 50 mm or more, or 55 mm or more, and may be 300 mm or less, 250 mm or less, 200 mm or less, 150 mm or less, 130 mm or less, 120 mm or less, 110 mm or less, or 100 mm or less. When the diameter of the direction changing roller falls within the above-mentioned range, the cracking of the electrode active material layer can be effectively reduced. It is to be noted that, in the direction changing roller having a so-called concave crown shape, the phrase “the diameter of the direction changing roller” may mean the diameter of a part having the largest diameter at both ends of the roller.

In the method of the present disclosure, the temperature of the stack at the time of direction change is not particularly limited, and may be 40° C. or more. When the temperature falls within the above-mentioned range, the cracking of the electrode active material layer can be effectively reduced. The temperature may be 50° C. or more, 60° C. or more, 70° C. or more, 80° C. or more, 90° C. or more, or 100° C. or more, and may be 150° C. or less, 140° C. or less, 130° C. or less, 120° C. or less, 110° C. or less, or 100° C. or less. The temperature can be set as appropriate in consideration of the softening temperature of the binder or the like. It is to be noted that the term “temperature” may particularly mean the temperature of the electrode active material layer within the stack.

The temperature of the stack may be monitored by, for example, a thermometer such as a temperature sensor. The thermometer may particularly be a non-contact radiation thermometer.

The conveyance speed of the electrode active material layer is not particularly limited, and can be set as appropriate in consideration of the viewpoint of reducing the cracking of the electrode active material layer, the viewpoint of easiness of conveyance, and the like.

In the method of the present disclosure, a direction changing roller may be used in a multistage manner in the conveyance direction of the electrode active material layer. The number of stages of the direction changing roller is not particularly limited, and can be set as appropriate from the viewpoints of reducing the cracking of the electrode active material layer and saving space.

The base material layer in the method of the present disclosure is not particularly limited, and examples of the base material layer include a current collector and a separation sheet. For example, when the base material layer is a current collector, the stack subjected to the method of the present disclosure can be directly used for manufacture of a battery. Further, for example, when the base material layer is a separation sheet, the electrode active material layer within the stack subjected to the method of the present disclosure can be separated from the base material layer that is the separation sheet, and an object obtained by transferring the electrode active material layer to a current collector can be used for the manufacture of the battery.

### Drying Step

The method of the present disclosure may further include drying the electrode active material layer before the roller-conveying, and the drying may include heating the stack 1 to a temperature of 120° C. or more.

In the drying step, for example, the stack 1 may be laser-heated, or may be infrared-heated. From the viewpoint of efficiently heating the stack 1, in particular, the heating step may include laser-heating the stack 1. Further, the drying step may use air blowing in combination. The air blowing may be hot air blowing.

The drying may be carried out by a predetermined heating unit 10. It is to be noted that the heating and the roller-conveying may be consecutively carried out or non-consecutively carried out. For example, in FIG. 1, the stack is roller-conveyed even during heating, and thus the heating and the roller-conveying are consecutively carried out. In contrast, the stack is not required to be roller-conveyed during heating, and thus the heating and the roller-conveyance may be non-consecutively carried out.

### Pressing Step

Although not shown, the method of the present disclosure may further include pressing the stack 1 before the roller-conveying. In particular, the pressing step may be performed before the drying step described above.

In the electrode active material layer that has been subjected to the pressing step, it is considered that the binder is pressed together, and thus the flexibility is reduced. Based on such estimation, it is particularly effective to apply the method of the present disclosure to the electrode active material layer that has been subjected to the pressing step.

The method of the pressing is not particularly limited, and can adopt a usual method.

The pressure of the pressing is not particularly limited, and can be set as appropriate such that the density of the electrode active material layer takes a desired value.

### Low-Temperature Drying Step

The method of the present disclosure may further include, before the pressing step, drying the electrode active material layer at a temperature lower than the temperature in the drying step described above. The drying temperature is this step may be 80° C. or more, 90° C. or more, or 100° C. or more, and may be 140° C. or less, 130° C. or less, or 120° C. or less.

### Battery

A battery of the present disclosure is manufactured by the method of the present disclosure of manufacturing a battery. In the battery of the present disclosure, cracking of the electrode active material layer that has been subjected to heat treatment is reduced.

The battery of the present disclosure includes an electrode stack, and may include an electrolyte layer as appropriate.

In the present disclosure, the term “electrode stack” means a stack of an electrode active material layer and a current collector, and means a component through which a current can flow. That is, when the base material layer is the current collector in the method of the present disclosure, the term “stack” means an electrode stack.

The battery of the present disclosure may be a liquid battery or a solid battery. It is to be noted that, in the present disclosure, the term “solid battery” means a battery using at least a solid electrolyte as the electrolyte, and thus the solid battery may use a combination of a solid electrolyte and a liquid electrolyte as the electrolyte. Further, the solid battery of the present disclosure may be an all-solid-state battery, that is, a battery using only a solid electrolyte as the electrolyte.

The battery of the present disclosure may be a primary battery or a secondary battery. The battery of the present disclosure may particularly be a lithium ion secondary battery.

The battery of the present disclosure may be a monopolar battery or a bipolar battery.

When the battery of the present disclosure is a monopolar battery, the “electrode stack” may be a negative electrode stack or a positive electrode stack. For example, when the electrode stack means the negative electrode stack, the negative electrode stack is a stack of a negative electrode active material layer and a negative electrode current collector. When the electrode stack means the positive electrode stack, the positive electrode stack is a stack of a positive electrode active material layer and a positive electrode current collector. From the viewpoint of more effectively reducing the cracking of the electrode active material layer, the electrode stack may particularly be the negative electrode stack.

When the battery of the present disclosure is a bipolar battery, the “electrode stack” may be a bipolar electrode stack. The bipolar electrode stack may include a negative electrode active material layer, a current collector, and a positive electrode active material layer in the stated order. When the electrode stack is a bipolar electrode stack and laser heating is performed in the drying step, the positive electrode active material layer may be irradiated with laser to be heated. Moreover, in this case, the negative electrode active material layer may be disposed on the outer side of the direction changing roller in the radial direction. That is, the negative electrode active material layer heated by the residual heat from the positive electrode active material layer that has been subjected to laser heating may be extended by the direction changing roller.

### Current Collector

As the current collector, it is possible to adopt a publicly-known one as the current collector of the battery. Examples of the current collector include a copper foil, a copper alloy foil, a nickel foil, an aluminum foil, an aluminum alloy foil, a stainless steel foil, and a carbon sheet.

When the battery of the present disclosure is a bipolar battery, the current collector may include two types of current collectors that are different from each other. In this case, the current collectors may be caused to adhere to each other via an electrically conductive adhesive layer, or may be joined to each other by pressing or the like. For example, the current collector on the negative electrode active material layer side may be a copper foil, and the current collector on the positive electrode active material layer side may be an aluminum foil.

The thickness of the current collector is not particularly limited, and may be 1 μm or more and 300 μm or less, 5 μm or more and 200 μm or less, or 10 μm or more and 100μm or less. When the current collector includes two types of current collectors that are caused to adhere to each other via the electrically conductive adhesive layer, the sum of the thicknesses of the respective layers may fall within the above-mentioned range.

The size of the current collector is not particularly limited, and can be set as appropriate in consideration of, for example, a desired battery capacity or the like.

The shape of the current collector is not particularly limited, and may be, for example, a quadrilateral shape such as a rectangular shape.

### Electrode Active Material Layer

The electrode active material layer contains an electrode active material and a binder, and may contain an electrically conductive auxiliary agent and other components as appropriate. In the present disclosure, the “electrode active material layer” may be a “negative electrode active material layer”or a “positive electrode active material layer”.

The electrode active material layer can be formed from an electrode mixed material slurry.

It is to be noted that, in the present disclosure, the term “mixed material” means a composition capable of configuring the electrode active material layer or the like as it is or by further containing other components. Further, in the present disclosure, the term “mixed material slurry” means a slurry containing a dispersion medium in addition to the “mixed material”, thereby being capable of forming the electrode active material layer or the like by applying and drying the mixed material slurry.

The thickness of the electrode active material layer is not particularly limited. The thickness of the electrode active material layer may be 10 μm or more and 500 μm or less, 100 μm or more and 450 μm or less, or 200 μm or more and 400 μm or less.

The size of the electrode active material layer is not particularly limited, and can be set as appropriate in consideration of, for example, the desired battery capacity or the like.

The shape of the electrode active material layer is not particularly limited, and may be, for example, a quadrilateral shape such as a rectangular shape.

### Electrode Active Material

The electrode active material is not particularly limited. In the present disclosure, the “electrode active material” may be used as any of a “negative electrode active material” or a “positive electrode active material”.

The negative electrode active material is not particularly limited as long as the negative electrode active material is a substance having a lower potential as compared with the positive electrode active material. When the electrode stack of the present disclosure is an electrode stack for a lithium ion secondary battery, examples of the negative electrode active material include: carbonaceous materials such as graphite (artificial graphite and natural graphite), resinous coal, carbon fibers, activated carbon, hard carbon, and soft carbon; metal-based materials mainly formed from tin, a tin alloy, silicon, a silicon alloy, gallium, a gallium alloy, indium, an indium alloy, aluminum, an aluminum alloy, and the like; electrically conductive polymers such as polyacene, polyacetylene, and polypyrrole; metallic lithium; lithium-titanium complex oxides such as Li₄Ti₅O₁₂; and lithium alloys such as an Li—Si alloy, an Li—Sn alloy, an Li—Al alloy, an Li—Ga alloy, an Li—Mg alloy, and an Li—In alloy. One type of the negative electrode active materials may be used alone, or two types or more of the negative electrode active materials may be used in combination.

The content of the negative electrode active material in the negative electrode mixed material serving as the electrode mixed material is not particularly limited, and may be 50% by mass or more, 70% by mass or more, 90% by mass or more, or 95% by mass or more.

The shape of the negative electrode active material may be, for example, a particle shape.

The positive electrode active material is not particularly limited as long as the positive electrode active material is a substance having a higher potential as compared with the negative electrode active material. When the electrode stack of the present disclosure is an electrode stack for a lithium ion secondary battery, examples of the positive electrode active material that can be used include: composite oxides such as a lithium cobalt oxide (LiCoO₂), a lithium nickel oxide (LiNiO₂), a lithium manganese oxide (LiMn₂O4), a solid solution oxide (Li₂MnO₃—LiMO₂ (M=Co, Ni, or the like)), a lithium nickel manganese oxide (LiNi_{1/2}Mn_{1/2}O₂), a lithium nickel manganese cobalt oxide (LiNi_{1/3}Mn_{1/3}Co_{1/3}O₂), an olivine-type lithium phosphorus oxide (LiFePO₄); electrically conductive polymers such as polyaniline and polypyrrole; sulfide-based positive electrode active materials such as an Li₂S, CuS, Li—Cu—S compound, a TiS₂, FeS, MoS₂, Li—Mo—S compound, an Li—Ti—S compound, and an Li—V—S compound; and materials using sulfur as an active material such as acetylene black impregnated with sulfur, porous carbon impregnated with sulfur, and mixed powder including sulfur and carbon. One type of the positive electrode active materials may be used alone, or two or more types of the positive electrode active materials may be used in combination.

The content of the positive electrode active material in the positive electrode mixed material serving as the electrode mixed material is not particularly limited, and may be 50% by mass or more, 70% by mass or more, 90% by mass or more, or 95% by mass or more.

The shape of the positive electrode active material may be, for example, a particle shape.

### Binder

In the present disclosure, the cracking of the electrode active material layer can be reduced by expanding and spreading the binder in a state of having flexibility.

The binder is not particularly limited, and, when the battery of the present disclosure is a lithium ion secondary battery, examples of the binder include polyvinylidene fluoride (PVdF), polytetrafluoroethylene, polyethylene, polypropylene, aramid resin, polyamide, polyimide, polyamide imide, polyvinyl alcohol, polyacrylonitrile, polyacrylic acid, poly(methyl acrylate), poly(ethyl acrylate), poly(hexyl acrylate), polymethacrylic acid, poly(methyl methacrylate), poly(ethyl methacrylate), poly(hexyl methacrylate), poly(vinyl acetate), poly(vinyl pyrrolidone), polyether, poly(ether sulfone), poly(hexafluoro propylene), styrene butadiene rubber, and carboxymethyl cellulose. One type of the binders may be used alone, or two or more types of the binders may be used in combination.

The content of the binder in the electrode mixed material is not particularly limited, and can be set as appropriate in accordance with the desired binding performance or the like.

### Electrically Conductive Auxiliary Agent

The electrically conductive auxiliary agent is not particularly limited, and, when the battery of the present disclosure is a lithium ion secondary battery, examples of the electrically conductive auxiliary agent include: graphites such as natural graphite and artificial graphite; carbon blacks such as acetylene black, Ketjen black, channel black, furnace black, lamp black, and thermal black; electrically conductive fibers such as carbon fibers like carbon nanotubes, and metal fibers; metal powders such as aluminum powder; electrically conductive whiskers such as zinc oxide whisker and electrically conductive potassium titanate whisker; electrically conductive metal oxides such as titanium oxide; and organic electrically-conductive materials such as phenylene derivatives. One type of the electrically conductive auxiliary agents may be used alone, or two or more types of the electrically conductive auxiliary agents may be used in combination.

The content of the electrically conductive auxiliary agent in the electrode mixed material is not particularly limited, and can be set as appropriate in accordance with the desired electrically conductive performance or the like.

### Other Components

The electrode mixed material may contain components other than the above. Examples of the components include a dispersant. Examples of the dispersant include carboxymethyl cellulose.

### Examples 1, 2 and Comparative Examples 1, 2

### Example 1

A stack including a base material layer and an electrode active material layer was laser-heated to 200° C. The stack was roller-conveyed so as to be changed in direction by 45° along the direction changing roller that was configured from three rollers as illustrated in FIG. 2 in which the circumferential speed of the both end rollers (the both end portions) was faster than the circumferential speed of the center roller (the center portion). After that, the stack was wound to wiring rollers having different diameters, and the diameter of the wiring roller at which the cracking occurred in the electrode active material layer was checked. The diameter of the winding roller was reduced by 5 mm from 90 mm. It is to be noted that cracking of the electrode active material layer in a winding roller having a large diameter means that the electrode active material layer is easily cracked. As a result, the cracking occurred in the electrode active material layer when a winding roller having a diameter of 35 mm was used. It is to be noted that, when similar evaluation was carried out before the laser heating, the cracking occurred in the electrode active material layer when a winding roller having a diameter of 50 mm was used. This means that, in Example 1, cracking was less likely to occur in the electrode active material layer after heating than before heating.

### Example 2

The electrode active material layer was roller-conveyed and evaluated similarly to Example 1 except that a direction changing roller configured from two rollers at both end portions as illustrated in FIG. 3 was used, a conveyance roller was further included on the upstream side from the direction changing roller in the conveyance direction, and the circumferential speed of the direction changing roller was faster than the circumferential speed of the conveyance roller. As a result, the cracking occurred in the electrode active material layer when the winding roller having the diameter of 35 mm was used.

### Comparative Example 1

The electrode active material layer was roller-conveyed and evaluated similarly to Example 1 except that the circumferential speed of the both end portions was set to be the same as the circumferential speed of the center portion. As a result, the cracking occurred in the electrode active material layer when a winding roller having a diameter of 90 mm was used. That is, the cracking occurred in the electrode active material layer when a winding roller having a diameter larger than Examples 1, 2 was used.

### Comparative Example 2

The electrode active material layer was roller-conveyed and evaluated similarly to Example 2 except that the circumferential speed of the direction changing roller was set to be the same as the circumferential speed of the conveyance roller. As a result, the cracking occurred in the electrode active material layer when the winding roller having the diameter of 90 mm was used. That is, the cracking occurred in the electrode active material layer when a winding roller having a diameter larger than Examples 1, 2 was used.

What is claimed is:

1. A method of manufacturing a battery, the method comprising roller-conveying a stack such that a conveyance direction of the stack that has been subjected to heating to a temperature of 120° C. or more is changed by 45° or more along a direction changing roller, the stack including a base material layer and an electrode active material layer, wherein
the direction changing roller is configured to widen the stack.

2. The method according to claim 1, wherein the direction changing roller includes a center portion and both end portions, and a circumferential speed of the both end portions is faster than a circumferential speed of the center portion.

3. The method according to claim 1, wherein
the direction changing roller is configured from two rollers at both end portions,
a conveyance roller is further included on an upstream side from the direction changing roller in the conveyance direction, and
a circumferential speed of the direction changing roller is faster than a circumferential speed of the conveyance roller.

4. The method according to claim 1, further comprising drying the electrode active material layer before the roller-conveying, wherein
the drying includes heating the stack to a temperature of 120° C. or more.

5. The method according to claim 4, wherein the drying includes laser-heating the stack.
